(19) United States
(12) Patent Application Publication
(10) Pub. No.: US 2018/0209450 A1
(43) Pub. Date: Jul. 26, 2018

(54) HYDRAULIC UPPER LINK

(71) Applicant: LOG Hydraulik GmbH, Essenbach (DE)

(72) Inventor: Georg Hadersdorfer, Porndorf/Bruckberg (DE)

(73) Assignee: LOG Hydraulik GmbH, Essenbach (DE)

(21) Appl. No.: 15/745,554

(22) PCT Filed: Jul. 22, 2016
(86) PCT No.: PCT/DE2016/100331

§ 371 Date: Jan. 17, 2018

(30) Foreign Application Priority Data
Jul. 24, 2015 (DE) 10 2015 112 165.4

(51) Int. Cl. F15B 11/10; F15B 1/027; F15B 1/02; F15B 20/00; A01B 59/06; A01B 63/10

(52) U.S. Cl. CPC F15B 11/10; F15B 1/027; F15B 1/024; F15B 2211/7053; A01B 59/066; A01B 63/10; F15B 2211/212; F15B 20/005

(57) ABSTRACT

The invention relates to a hydraulic upper link for a three-point hydraulic lift, including a hydraulic system that includes a hydraulic piston and a hydraulic cylinder, the hydraulic piston being at least part of a lever arm of the upper link. It is essential that in an area of the annular space, at least one accumulator is connected at a certain preloaded pressure to the hydraulic system via a hydraulic line.

### BACKGROUND

The invention relates to a hydraulic upper link for a three-point hydraulic lift as well as a three-point hydraulic lift.

Hydraulic upper links are commonly used in the field of utility vehicles, particularly agricultural utility vehicles, in order to couple a tool, for example a plough, to the agricultural utility vehicle, such as a tractor. Here, the tool is coupled via a three-point hydraulic lift to the utility vehicle. The three-point hydraulic lift used shows typically two lower links as well as one upper link, which in turn at one side are fastened at the utility vehicle and at the other side at the tool. These upper links typically comprise a hydraulic cylinder for adjusting the upper link.

In hydraulic upper links typically two operating conditions are known: for transportation the tool is usually raised, in the operating mode the tool is usually lowered.

The three-point hydraulic lifts known from prior art commonly lead to oscillating motions during transportation, which develop from an uneven terrain or the like. In order to avoid these oscillations it is known in prior art to lower the lower links and thus also the tool for damping during transportation.

This way of damping during transportation known from prior art is disadvantageous in that by lowering the lower link and thus lowering the front of the tool, due to the distribution of force and the lever effect, the risk is given that the frontal axle of the utility vehicle loses contact with the ground.

In order to avoid this, expensive technology is required, which cannot be economically retrofitted.

### SUMMARY

The present invention is therefore based on the objective to suggest an upper link and/or a three-point hydraulic lift which prevents the build-up vibration of the tool.

This objective is attained in a hydraulic upper link as well as a three-point hydraulic lift having one or more features of the invention. Preferred embodiments of the hydraulic upper link are disclosed below and in the claims

The hydraulic upper link according to the invention comprises, as commonly known, a hydraulic system with a hydraulic cylinder, comprising a cylinder tube and a cylinder piston. The hydraulic cylinder represents at least partially a lever arm of the upper link. Such an upper link is commonly used in a three-point hydraulic link. For this purpose, the upper link can be fastened at one end to a utility vehicle and at the other end, typically the end of the piston rod, to a tool. When a tensile force is applied upon the upper link the tensile force acts therefore upon the piston rod of the hydraulic cylinder. An inverse fastening is however also covered by the scope of the invention.

It is essential that at a side of the annular space around the piston rod, at least one pressure accumulator with a preloaded pressure is connected via a hydraulic line to the hydraulic system.

The upper link according to the invention differs therefore in essential aspects from the upper links of prior art:

By this pressure accumulator the hydraulic system is preloaded on one side to a certain pressure. In case of a tensile stress being applied and a certain force limit being exceeded, the piston rod is pulled out such that the coupled tool is lowered. The preloading pressure of the pressure accumulator predetermines a force limit at which the upper link expands by the piston rod being pulled out of the cylinder tube. Here, the lower links of the three-point hydraulic link remain in the same position so that the rear part of the tool drops downwards.

This leads to the advantage that any build-up vibration of the tool, for example when driving over an uneven terrain, is avoided. The damping effect by lowering the rear part of the tool is increased by the lever effect.

The pressure accumulator can also be used for amplifying traction. With the preloaded pressure of the pressure accumulator here a tensile force at the upper link can be actively generated. This leads to the advantage that more weight rests on the rear axle of the utility vehicle and/or the tractor, as well as the rear part of the tool. This amplifies traction and thus the propulsion.

When the piston rod is pulled out of the cylinder tube this occurs preferably without any reflux of hydraulic fluid into the hydraulic cylinder, thus a slight vacuum develops in the hydraulic cylinder. However, it is relatively weak, when compared to the preloaded pressure of the pressure accumulator, and thus it can be neglected. At the annular space hydraulic fluid is released by the hydraulic line into the pressure accumulator.

In a preferred embodiment the preloaded pressure of the at least one pressure accumulator can be adjusted, preferably from 20 to 150 bar, particularly preferred from 30 to 100 bar, most preferred to 100 bar.

The pressure accumulator is preferably embodied as a piston accumulator, member accumulator, or bladder accumulator. Most preferred, the pressure accumulator is embodied as a nitrogen-filled accumulator.

A force limit for the tensile stress of the upper link can be adjusted via the preloaded pressure of the pressure accumulator. If the tensile stress at the upper link is lower than the force limit, the hydraulic piston is not pulled out of the hydraulic cylinder, i.e. the upper link remains unchanged in its length. When the force limit is exceeded, i.e. when the tensile stress at the upper link is greater than the force limit, the hydraulic piston is pulled out of the hydraulic cylinder and the upper link extends. Upon exceeding the force limit preferably a very rapid extension of the hydraulic piston is possible.

Preferably the force limit is adjusted to the weight of the tool.

In another preferred embodiment a return throttle valve is provided as a damping element in the hydraulic line between the hydraulic system and the pressure accumulator. The return throttle valve is here arranged between the hydraulic system and the pressure accumulator such that upon the hydraulic piston being pulled out of the hydraulic cylinder the flow of hydraulic fluid into the pressure accumulator is not hindered. This leads to the advantage that the hydraulic piston, upon the force limit being exceeded, can be pulled out very rapidly. When the hydraulic fluid returns into the hydraulic cylinder, upon the hydraulic piston being pushed back into the hydraulic cylinder, the throttle of the return throttle slows the reflux of the hydraulic fluid. This way any build-up vibrating of the upper link is prevented.

As commonly known in hydraulic systems, a valve and the corresponding control block are provided as a safety measure for a broken line. For this purpose, the hydraulic lines are closed at both sides at the hydraulic cylinder in the blocking direction with a return valve. This prevents the tool from falling down in case of a defect at the hydraulic line. This way, the hydraulic fluid is kept inside the hydraulic system. If necessary, for example in order to change the length of the upper link, the utility vehicle can resupply hydraulic fluid.

In a preferred embodiment of the invention a shut-off valve is provided in the hydraulic line between the hydraulic system and the pressure accumulator. Preferably, the shut-off valve is arranged between the return throttle valve and the hydraulic system. The shut-off valve and the return throttle valve may also be embodied combined, forming one valve, for example embodied as a magnetically controlled valve.

In an alternative, preferred embodiment at least one pressure accumulator is integrated in the hydraulic cylinder. This may for example occur in the form of a piston accumulator.

In another preferred embodiment of the invention, at the side of the annular space, a second pressure accumulator is provided with a second pressure, preferably a lower pre-loaded pressure for amplifying traction. Depending on the embodiment and the load of the attached tool, in the upper links known from prior art no load is applied to the upper link in the operating state. The weight of the tool is here carried exclusively by the lower links.

By the second pressure accumulator for amplifying traction a tensile force can be actively generated at the upper link. This leads to the advantage that more weight rests on the rear axle of the tool and/or the rear area of the tool. This amplifies traction and thus the propulsion.

Due to an uneven terrain, for example, a relative motion develops between the tractor and the tool. When using the second pressure accumulator (amplification of traction) the piston rod of the upper link adjusts to the uneven surface such that the tensile force for amplifying traction is essentially kept constant by the second pressure accumulator.

In order to amplify traction, preferably a pressure is applied in the second pressure accumulator of 5 to 50 bar, particularly preferred approximately 30 bar.

In one preferred embodiment, at least one pressure accumulator for damping the upper link and/or the second pressure accumulator for amplifying traction are embodied jointly integrated in the hydraulic cylinder. This can occur for example via a piston or membrane accumulator.

The upper links are commonly embodied either at both ends with a loop or a ball head. Alternatively, a tail hook may be provided at one end. Usually the upper link is fastened with the end of the loop at the utility vehicle, while the tool can be fastened at the tail hook or the other loop.

The objective according to the invention is further attained in a three-point hydraulic lift with two lower links and one upper link.

Three-point hydraulic lifts show typically two lower links and one upper link, which on the one side are fastened at the utility vehicle and on the other side at the tool. The upper link is here usually embodied as a hydraulic upper link with a hydraulic system for adjusting the upper link.

According to the invention the three-point hydraulic lift is embodied with a hydraulic upper link, which at the side of the annular space comprises at least one pressure accumulator with a preloaded pressure, which is connected via a hydraulic line to the hydraulic system.

### BRIEF DESCRIPTION OF THE DRAWINGS

In the following, additional preferred features and variants of the upper link according to the invention are explained based on exemplary embodiments and the figures.

Shown here are:

FIG. 1 a schematic illustration of a first exemplary embodiment of the upper link according to the invention;

FIG. 2 a schematic illustration of a second exemplary embodiment of the upper link according to the invention with amplified traction; and

FIG. 3 a diagram for an exemplary embodiment of an upper link according to the invention.

### DETAILED DESCRIPTION OF THE PREFERRED EMBODIMENTS

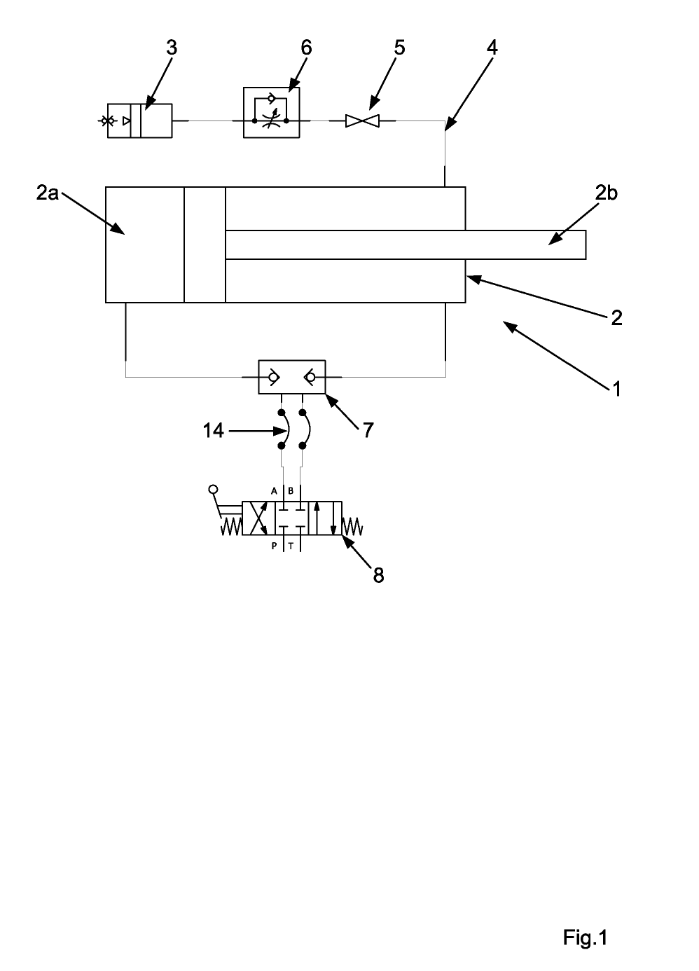

In FIGS. 1 to 3 identical reference characters mark identical elements or elements having the same effect.

FIG. 1 shows a schematic illustration of a first exemplary embodiment of an upper link 1 according to the invention.

The upper link 1 is embodied as a hydraulic upper link comprising a hydraulic system 2 with a hydraulic cylinder showing a cylinder tube 2a and a piston rod 2b. The hydraulic cylinder 2 is a part of the lever arm of the upper link 1.

As commonly known, the upper link 1 is embodied at one end with a loop (not shown) and at the other end with a tail hook (not show, either).

At the side of the annular space a pressure accumulator 3 is connected via a hydraulic line 4 to the hydraulic system 2. A shut-off valve 5 and a return throttle valve 6 are arranged between the pressure accumulator 3 and the hydraulic system 2.

As a safety measure for a broken line a barring block 7 is provided, which can be controlled via a control 8 of the utility vehicle (not shown).

The barring block 7 is connected via the hydraulic line 14 to the control unit 8.

The pressure accumulator 3 is a gas accumulator filled with nitrogen, in the present case embodied as a piston accumulator. The upper link is preloaded by the pressure accumulator 3 at one side to a preloaded pressure of approximately 100 bar. By the preloaded pressure a pressure limit can be adjusted for the tensile stress of the upper link 1. In the present case the pressure limit is adjusted to the weight of the tool.

When transporting a tool (not shown), particularly a plough, the tool is coupled to the utility vehicle (not shown). The weight of the tool applies tensile stress upon the hydraulic upper link 1. The front axle of the utility vehicle is this way released. A released front axle may show an instable steering behavior.

Additional stress at the utility vehicle and at the tool develops for example by uneven road conditions or by headland turns in the field and lead to vibrations of the mechanical system. This additional stress can lead to mechanical failure, under certain circumstances.

With the hydraulic upper link 1 according to the invention, showing a transportation damping effect, this additional stress can be considerably reduced. In case of an additional stress, which exceeds the force limit adjusted by the pressure accumulator 3, the upper link 1 is changed in its length. The force limit can this way be adjusted such that it is approximately equivalent to the weight of the tool itself.

In the area of the hydraulic cylinder facing away from the piston rod 2b, in case of a tensile stress applied and the piston rod 2b being pulled out, no hydraulic fluid is resupplied. Thus, a slight vacuum develops in the piston tube 2a.

Upon exceeding the force limit, for example by additional stress applied due to uneven terrain, the piston rod 2b is pulled out of the piston tube 2a. The hydraulic oil flows via a damping throttle, embodied as a return throttle valve 6, into the pressure accumulator 3 filled with nitrogen. The return valve 6a is in the open state in the direction from the hydraulic cylinder to the pressure accumulator 3.

By the pressure accumulator 3, acting as an elastic damping element, the pressure increase occurs at a slowed speed in the upper link. The tool lowers over a certain damping path. The adjustable throttle valve 6b prevents the attached device from being raised excessively fast to its original position by the now higher pressure in the pressure accumulator 3.

For tasks in which the damping may have disturbing effects, the pressure accumulator can be deactivated via a manually or magnetically operated shut-off valve 5.

When transporting the tool, the tool is coupled to a utility vehicle, as described above. The weight of the tool applies tensile stress upon the hydraulic upper link 1. The front axle of the utility vehicle is this way released. A released front axle may show an instable steering behavior. By changing the length of the upper link when tensile stress is applied the tool is lowered. Here, the lower links remain in an unchanged position such that the frontal connection points of the tool are fixed.

The rear area of the tool therefore sinks downward. The damping effect by such lowering of the rear part of the tool is increased by the lever effect. The lowering of the tool in the rear section prevents therefore that the front axle of the utility vehicle, due to excess stress on the rear axle, is lifted and this way the steering behavior of the vehicle is improved.

In the following, only the differences between the figures shall be discussed in order to avoid unnecessary repetitions.

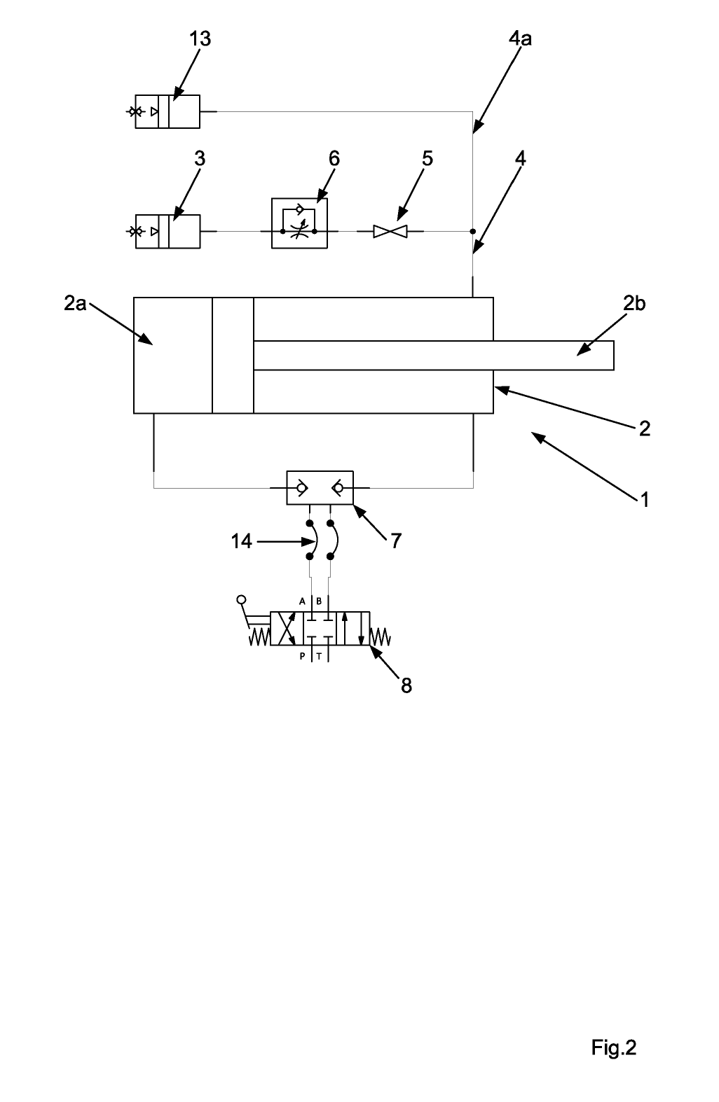

FIG. 2 shows a schematic illustration of another exemplary embodiment with amplified traction.

In FIG. 2 the hydraulic upper link comprises a second pressure accumulator 13 for amplifying traction. The second pressure accumulator 13 is also connected at the annular side to the hydraulic system 2. The pressure accumulator 13 is embodied with a preloaded gas pressure of approx. 30 bar.

With the additional pressure accumulator 13 a tensile force can be actively generated at the upper link 1. This leads to a tipping of the tool and thus a higher stress upon the rear section of the tool. This amplifies traction and thus the propulsion.

By the use of the second pressure accumulator 13 (amplifying traction) the piston rod 2b of the upper link adjusts to uneven terrain such that the tensile force for amplifying traction is essentially kept constant by the second pressure accumulator 13.

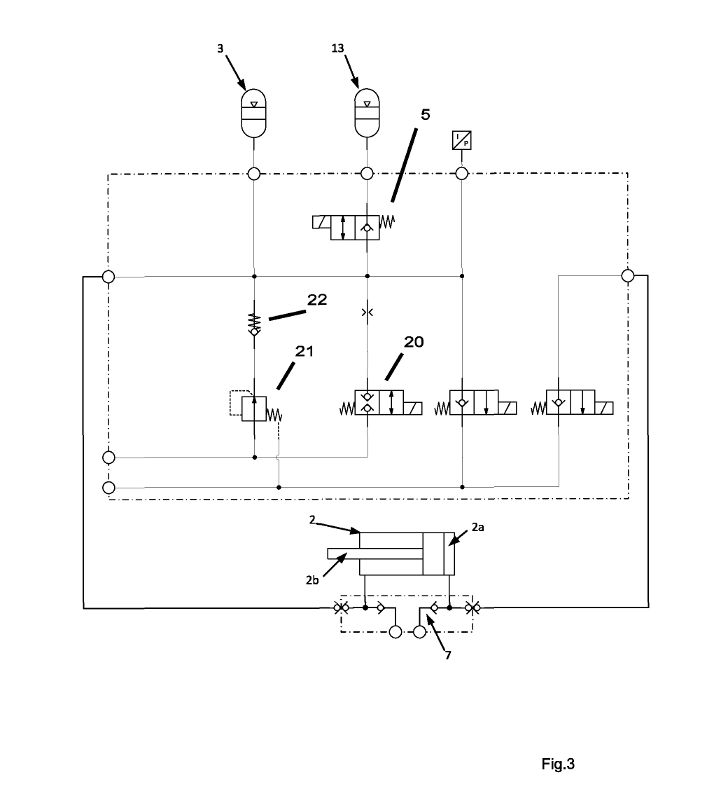

FIG. 3 shows a diagram for an upper link according to the invention.

The hydraulic upper link 1 is embodied with a first pressure accumulator 3 for damping during transportation and a second pressure accumulator 13 for amplifying traction.

The first pressure accumulator 3 for damping during transportation is embodied as a 0.5 liter accumulator with 135 bar preloaded pressure.

The return valve 22 keeps the pressure constant in the hydraulic system.

The second pressure accumulator 13 for amplifying traction is embodied as a 0.5 liter accumulator with 50 bar preloaded pressure.

In order to adjust the desired pressure for amplifying traction two control valves 20, 21 are provided. However it is also possible to provide only one of the two valves.

Additionally, a shut-off valve 5 is provided, in the present case an electric shut-off valve. For raising the tool or for transportation the amplification of traction can be deactivated thereby.

1. A hydraulic upper link for a three point hydraulic lift comprising a hydraulic system with a hydraulic cylinder comprising a cylinder tube and a piston rod, the hydraulic cylinder being forming at least a part of a lever arm of the upper link, at least one pressure accumulator with a preloaded pressure, the at least one pressure accumulator being connected via a hydraulic line to the hydraulic system at a side of the annular space around the piston rod.

2. The hydraulic upper link according to claim 1, wherein the preloaded pressure of the at least one pressure accumulator is adjustable.

3. The hydraulic upper link according to claim 1, wherein the at least one pressure accumulator is embodied as a piston accumulator, membrane accumulator, or bladder accumulator.

4. The hydraulic upper link according to claim 1, wherein a limit for a tensile force on the upper link is adjustable by the at least one pressure accumulator.

5. The hydraulic upper link according to claim 1, further comprising a return throttle valve in the hydraulic line between the hydraulic system and the pressure accumulator.

6. The hydraulic upper link according to claim 1, further comprising a shut-off valve in the hydraulic line between the hydraulic system and the pressure accumulator.

7. The hydraulic upper link according to claim 1, further comprising at a side of the annular space a second pressure accumulator with a second preloaded pressure for amplifying traction.

8. The hydraulic upper link according to claim 1, further comprising at least one of load balance valves or return valves that are releasable in effective connection to the hydraulic cylinder as a safety measure in case of a broken line.

9. The hydraulic upper link according to claim 7, wherein at least one of the at least one pressure accumulator or the second pressure accumulator are embodied integrated in the hydraulic cylinder.

10. The hydraulic upper link according to claim 1, wherein the upper link is embodied at one end with at least one of a loop or at one end with a tail hook and at the other end with a loop.

11. A three-point hydraulic lift with two lower links and one upper link, wherein the upper link is embodied according to claim 1.

12. The hydraulic upper link according to claim 2, wherein the preloaded pressure of the at least one pressure accumulator is between 20 and 150 bar.

13. The hydraulic upper link according to claim 7, wherein the second preloaded pressure in the second pressure accumulator is lower than the preloaded pressure of the at least one pressure accumulator.
